(19) United States
(12) Patent Application Publication
(10) Pub. No.: US 2005/0125237 A1
(43) Pub. Date: Jun. 9, 2005

(54) System for selling real estate products and services through the internet

(76) Inventor: Craig Harrison, Fort Collins, CO (US)

Correspondence Address: COCHRAN FREUND & YOUNG LLC, 2026 CARIBOU DR, SUITE 200, FORT COLLINS, CO, 80525, US

(21) Appl. No.: 10/139,158

(22) Filed: May 2, 2002

Related U.S. Application Data
(60) Provisional application No. 60/288,815, filed on May 4, 2001.

(51) Int. Cl. G06F 17/60

(52) U.S. Cl. 705/1

(57) ABSTRACT

Disclosed is a system that effectively gathers searchers of real estate products and services by using a large interconnected tree of geographically descriptive terms in combination with descriptive terms relating to real estate. The system allows searchers to connect to desired products and services in a very few number of clicks as compared to searching for real estate products and services using brand names. Various techniques are used to allow the searcher to obtain information on real estate products and services that relate to specific geographical locations. Searchers are encouraged to first link to sites that provide the highest referral fees. The wide net that is cast by the large domain name tree that includes various geographic descriptors, as well as real estate descriptors, and which is extensively interlinked, provides an effective way of obtaining a large number of searchers and specifically qualified leads for real estate services and products.

### BACKGROUND OF THE INVENTION

a. Field of the Invention

The present invention generally pertains to methods of selling products and services over the Internet and more particularly to the cross selling of real estate products and services using geographically descriptive terms in combination with descriptive terms relating to real estate that are combined and used as domain names.

b. Description of the Background

The general public, as well as business customers, are using the Internet more frequently to purchase products and services. Various companies have attempted to sell products and services over the internet using a wide variety of techniques. Many of the well-funded dot.com companies have gone out of business because of techniques that these companies have used to market their products and services. For example, many well-funded dot.com companies have relied upon standard brick and mortar techniques for marketing, such as through newsprint, television, and radio. It has been found that these types of marketing techniques are expensive and do not produce the customer base that justifies a return on investment for this type of marketing.

Hence, other techniques of selling products and services over the Internet must be employed to obtain a sufficient customer base at a reasonable cost to realize a reasonable return on investment.

In the process of selling real estate products and services over the Internet, companies have marketed their brand names. For example, real estate companies may provide Internet sites under their brand name and may have links to other products and services, such as lending institutions that are also marketed under that lending institution's brand name. These companies attempt to rely upon the goodwill generated by their particular brand name in attracting customers. This process has been only moderately successful for these institutions.

However, the sale of real estate products and services is, by definition, highly geographically dependent. A buyer may be familiar with a real estate company such as Remax, Coldwell Banker, Better Homes and Gardens, etc., and log onto such a brand name site. The brand name site may then direct that buyer to specific geographical locations such as offices of that vendor located in a particular state or specific cities in that state. However, the buyer does not know if the brand name vendor is a large, active seller of real estate in that state, or any particular city in that state. Additionally, brand name vendors may not even have an office in a particular city in which the buyer is interested in purchasing real estate, which may frustrate the searcher and diminish the searchers opinion of that brand name. Further, the brand name site may not be sophisticated enough to provide links to local offices. For example, a search of a particular brand name may only provide sales propaganda attempting to bolster the brand name. Hence, the buyer would not be able to obtain the geographically dependent information in which the buyer is interested in a simple and easy manner, i.e., a viable seller of real estate products and services in a particular geographical location. Also, links to related products and services, such as financial products from lenders who lend in a particular geographical area may not be provided.

Hence, a brand name independent intermediate service that is based upon geographically descriptive information and descriptive terms relating to real estate is needed.

### SUMMARY OF THE INVENTION

The present invention overcomes the disadvantages and limitations of the prior art by providing an intermediary Internet based marketing service (“Intermediary”) that provides geographical descriptors of real estate products and services together with descriptive terms relating to real estate that are used as domain names in a large interlinked tree. In accordance with the present invention, a collection of geographically descriptive domain names is used in association with the real estate market to attract users and guide search engines to the Intermediary sites. The large interlinked tree of sites are then used to link to real estate products and services that are available in a geographical area of interest for the buyer. Payments are then made to the Intermediary by the vendors of products and services based upon the number of links provided by the Intermediary to the products and services vendors. The geographically descriptive domain names are therefore brand name independent and, as such, enjoy the status of an independent vendor that is not attached to any particular brand name. Further, the geographically descriptive domain names are capable of attracting a larger customer base because of the ability to create hits through search engines that inherently operate in a fashion that attracts searchers to a geographically descriptive domain name site for real estate products and services.

The present invention may therefore comprise a method of obtaining referral fees by providing Internet searchers to vendors of real estate products and services comprising: obtaining a large tree of Internet domain names that include a geographically descriptive portion and a descriptive portion relating to real estate; encouraging searchers to access products and services first that provide larger referral fees; providing links to specific communities within a geographically descriptive domain name.

An advantage of the present invention is that a broad customer base of purchasers of real estate products and services (buyers) can be generated through the use of geographically descriptive terms and descriptive terms relating to real estate that are combined and used as domain names. A large interlinked tree of such domain names increases the probability of hits through interconnected links by widening the basis for search hits. Additionally, use of such domain names can significantly reduce the number of clicks required to access the desired information in contrast to advertising using the brand name.

Another advantage to the present invention is that the geographically descriptive domain names inherently enjoy at least an appearance of having an independent status as opposed to brand names. In that fashion, the owner of the family of the geographically descriptive names for real estate products and services (Intermediary) is capable of providing more links to brand name sites of various disparate real estate products and services in a particular geographical area and, as such, will generate a large number of referral fees. Additionally, the inherent nature of search engines is to access generic descriptors such as the geographically descriptive domain names for real estate products and services. This, together with the tendency of searchers to perform searches in that fashion, will result in a large number of relevant hits.

Each of these unique advantages are particularly tied to the fact that real estate products and services are by their nature geographically dependent and that a family of combined geographically descriptive and real estate descriptive domain names can be used to provide the Intermediary services.

### BRIEF DESCRIPTION OF THE DRAWINGS

In the drawings,

FIG. 1 is a diagram illustrating the manner in which non-brand name geographical descriptions result in a larger number of hits than brand name descriptions.

FIG. 2 is a diagram illustrating the number of clicks required to obtain the desired information for brand names versus geographically descriptive names for real is estate products and services.

FIG. 3 is a diagram illustrating the manner in which searchers can be directed to the purchase of financial products prior to searching real estate listings.

FIG. 4 is a sample redirection home page for Colorado real estate listings.com.

FIG. 5 is a chart illustrating the number of hits on brand name and non-brand name sites.

FIG. 6 is a chart illustrating the number of users of various search engines.

### DETAILED DESCRIPTION OF THE INVENTION

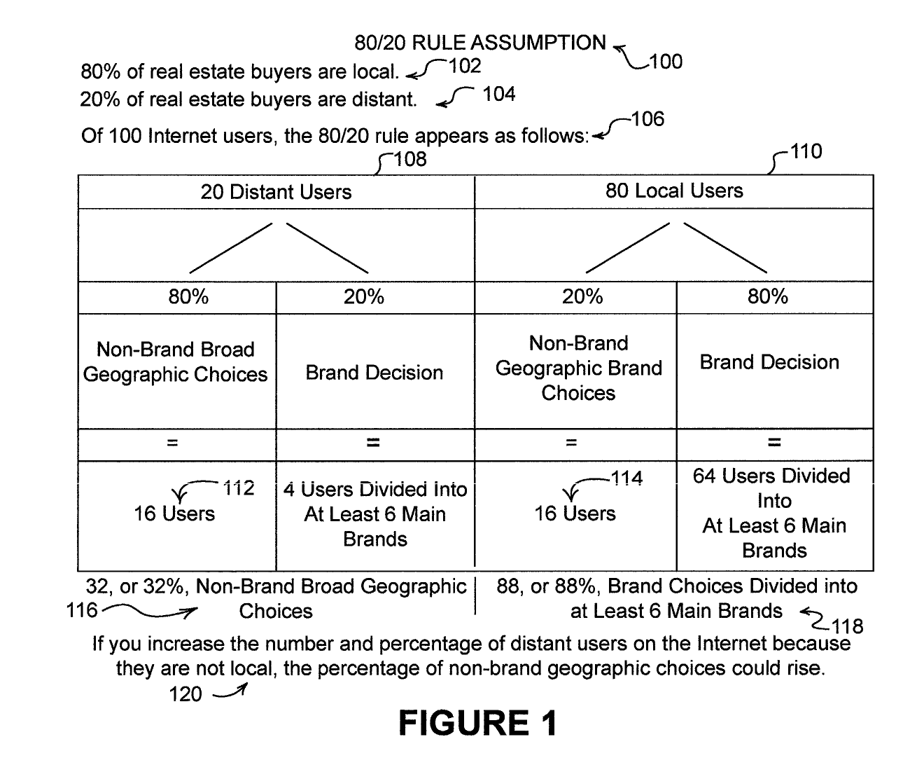

FIG. 1 is a diagram illustrating the manner in which a large interlinked tree of non-brand name, geographically descriptive domain names for real estate products and services is able to produce a greater number of hits than brand name domain names. FIG. 1 is based upon the 80-20 assumption rule. Statistical data has indicated that 80 percent of the purchasers of residential real estate are local purchasers, while 20 percent are distant purchasers, i.e., outside of the local real estate market. Statistical data has also shown that the 80-20 rule applies to searchers that use geographically descriptive terms versus brand names. For example, as shown in FIG. 1, for a group of 100 Internet searchers, 20 of the Internet searchers would be distant searchers using the 80-20 rule, while 80 of the searchers would be local searchers. Of the 20 distant searchers, 16 would use geographically descriptive terms in their searching, while 4 of the 20 distant searchers would use brand names, applying the 80-20 assumption rule to brand name versus generic searching, as explained below.

Local searchers are normally familiar with local real estate companies. Again, statistics indicate that the 80-20 assumption rule applies such that 80 percent of the local searchers will search on brand names, while 20 percent of the local searchers will search on geographically descriptive terms. As a result, 16 searchers would provide hits on geographically descriptive terms, while 64 searchers would provide hits on brand name searches. Hence, a total of 32 searchers, of the 100 total searchers, would provide hits on the geographically descriptive terms, while a total of 68 of the searchers would provide hits on brand names. Of course, an assumption could also be made that distant searchers if may be more likely to search for real estate products on the Internet, rather than local searchers, so that the percentage of hits on geographically descriptive terms would be higher. Of course, the 68 percent of searchers that search on brand names are divided between each of the brand names. Any particular city may have 5 to 10 prominent brand names with which local searchers may be familiar.

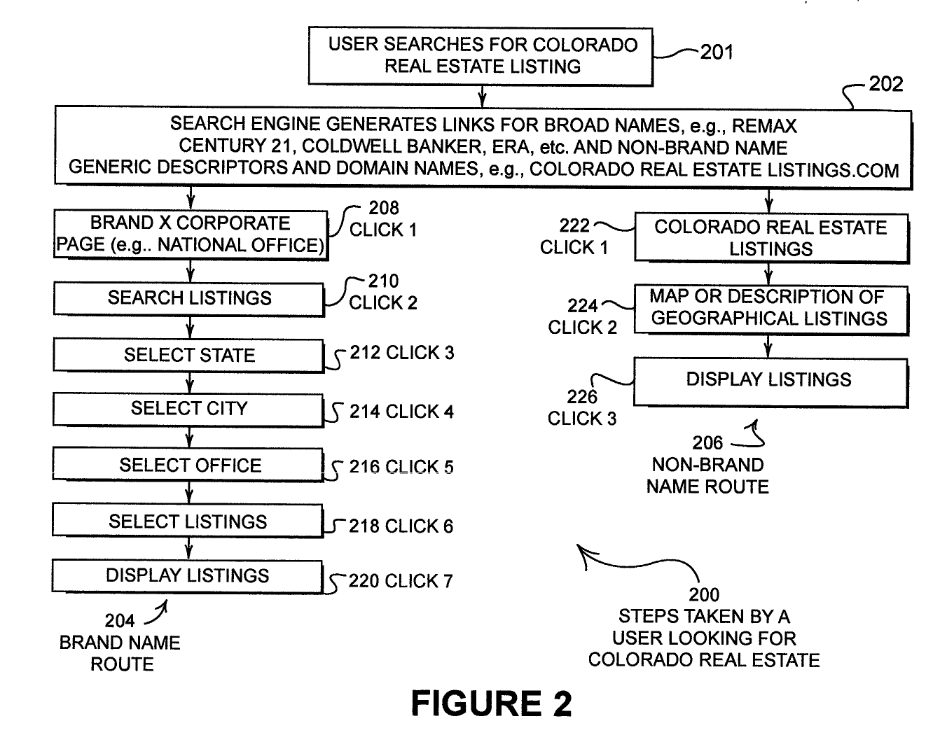

FIG. 2 illustrates the steps 200 taken by a user looking for Colorado real estate listings. FIG. 2 illustrates the number of steps required when a user takes the brand name route 204 verses the non-brand name route 206. As shown in step 201, the user searches for Colorado real estate listings using a search engine. At step 202, the search engine generates links for brand names such as Remax, Century 21, Coldwell Banker, ERA, etc. and for non-brand name generic descriptors and domain names, for example, coloradorealestatelistings.com. The user can then choose to select a brand name route 204 or the non-brand name route 206. If the user selects the brand name route 204, for example, the searcher may select a brand name from the search engine such as Remax. The searcher is then connected to the brand X corporate page such as the Remax page that may be handled by the national office of Remax. An option may be provided on the national web page to search listings as shown at step 210. At step 212, a state or other geographical area may be selected for viewing the real estate listings. At step 214, a city may be selected within the state. At step 16, the user may select a particular office in the selected city. At step 218, the user can then select listings provided by that office. At step 220 the listings are displayed for that office in that particular city.

As shown in FIG. 2, the brand name route 204 may result in as many as seven clicks in order to actually view listings. On the other hand, if the user selects the non-brand name route 206, through the selection of a generic listing, such as “Colorado real estate listings,” many fewer clicks are required to get to the actual listings. At step 222, for example, the user selects Colorado real estate listings. At step 224 a map or description of the geographical listings (descriptors) can be displayed. The user can then select the particular area such as a city or a suburb for display of those listings at step 226. The use of generic descriptors or generic domain names such as “Colorado real estate listings” serves several advantageous functions. First, it avoids all of the steps that are required in winding through the national office web pages of a brand name real estate company. Second, the use of generic descriptors or generic domain names allows for connection directly to a map or other description of geographical listings that can take the buyer directly to the listings desired based upon the geographically descriptive terms that have been used. This map or list of generic descriptors can be generated by the Intermediary, or a link can be provided directly to a map or list of generic descriptors provided by a local or national office of a brand name real estate company. In this fashion, a number of other steps can be eliminated. Further, the Intermediary can enter into an agreement with a particular brand name real estate company to obtain referral fees by way of an agreement between the real estate company and the Intermediary. Hence, the use of the generic listings requires a significantly reduced input by the searcher and, for that reason, is more likely to produce hits during the search process.

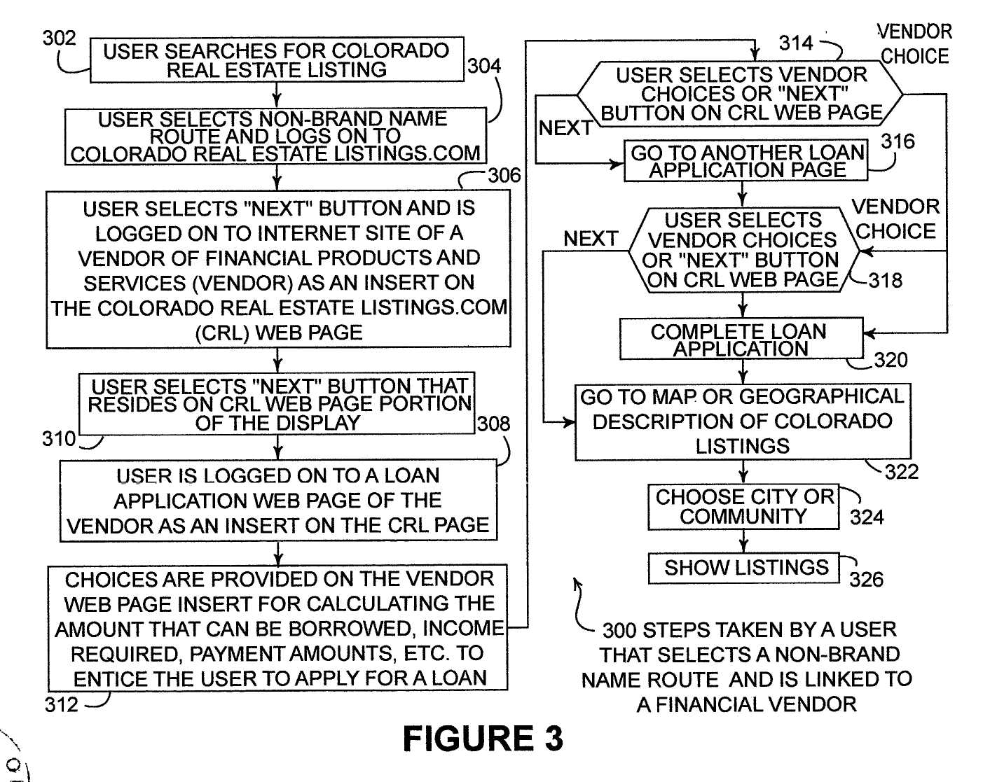

FIG. 3 is a flow diagram illustrating the steps that may be taken by a user that selects the non-brand name route to search for real estate listings and is linked to a vendor of financial products and services for prequalification. Links may be organized in accordance with FIG. 3 in a way that prioritizes connections to vendors that pay the highest referral fees. At step 302 the user searches for the generic descriptor “Colorado real estate listings.” At step 304 the search engine accesses the domain name “coloradorealestatelistings.com.” The user selects this geographically descriptive generic domain name, as indicated at step 304, because of the authenticity associated with the fact that this geographically descriptive generic name is being used as an actual registered domain name and because of its lack of affiliation with any particular brand name. At step 306 the user can select the “next” button and the Intermediary's web site logs the user onto an Internet site for a vendor of financial products and services. The vendor's web page appears as an insert on the Intermediary's web page “coloradorealestatelistings.com.” Of course, any desired vendor of products and services can be used other than financial products and services. However, vendors of financial products and services will normally pay high referral fees for obtaining potential borrowers in a particular geographical area in which that vendor provides loans. Also, real estate sales companies will pay higher referral fees for potential buyers, especially potential buyers that are prequalified. In this fashion, it is advantageous to first link the user to the financial vendor's web site and encourage that user to prequalify for a loan using the financial vendor's prequalification tools such as a calculator, etc.

As shown in step 308 of FIG. 3, the user can either select one of the prequalification routes indicated by the vendor's web page insert or the user can select the “next” button that resides on the coloradorealestatelistings.com web page portion of the display. In either event, the user is logged onto a loan application web page of the vendor at step 310. Of course, the loan application web page remains as an insert to the coloradorealetatelistings.com web page.

At step 312, choices are provided for the user on the vendor web page insert for calculating the amount that the user can borrow, the income required of the borrower, payment amounts and other similar information. This is used to entice the user to apply for a loan. Further, descriptions are provided as to the advantages of prequalifying for a loan. For example, the web page may indicate that offers may be more readily accepted, especially in a bidding war, if the purchaser is prequalified for a loan. At step 314, the user can either select one of the vendor choices on the vendor page insert or the “next” button on the coloradorealestatelistings.com web page. When the user selects the “next” button on the coloradorealestatelistings.com web page, the coloradorealestatelistings.com web page can link the user back to another different loan application page of the vendor, such as illustrated at step 316. Of course, an alternate vendor can also be accessed at this point since the “next” button resides on the web page owned by the Intermediary.

If the “next” button is selected, the process proceeds to step 316 and another loan application page is provided on the vendor insert. The process then proceeds to step 318 where the user can select one of the vendor choices, such as proceeding through the process of prequalification, or again select the “next” button on the coloradorealestatelistings.com web page. If the user selects one of the vendor's choices at either step 314 or step 318, the process then proceeds to step 320 where the user is encouraged to complete the loan application. The loan application or other data provided by the vendor remains as an insert in the Intermediary's web page at coloradorealestatelistings.com. In this manner, the user can select the “next” button at any time and proceed to step 322. At step 322 a map illustrating geographical areas in Colorado can be displayed. For example, the map may include a number of cities within Colorado which the user can select. Alternatively, the series of geographical descriptors can be provided as a listing of cities or suburbs or other communities so that the user can select from one of these alternatives. The map or geographical descriptors can be provided by the Intermediary. Alternatively, the user can be linked directly to a brand name real estate sales company that provides such a web page and has agreed to pay referral fees to the Intermediary. At step 324, the user can then choose a city or community from the geographical descriptors or map to access listings provided for that geographical area, as indicated at step 326.

FIG. 3 is a schematic illustration of the manner in which searchers are directed to particular links that are intended to cross-sell various products and services. Such links may be organized in a way that prioritizes connections to vendors that pay the highest referral fees. The first step, illustrated at 300 of FIG. 3, indicates that the user searches on the generic description “Colorado real estate.” The search request causes the search engine to access the domain name “coloradorealestatelistings.com” as indicated at 302. At step 2, illustrated at 304, the searcher accesses the “coloradorealestatelistings.com” web site and is asked if the searcher would like to inquire as to how much money can be borrowed to purchase a piece of real estate. The purpose of step 2, of course, is to direct the searcher to a vendor of financial products and services that will pay a referral fee to the owner of the generic name “coloradorealestatelistings.com.” The Intermediary may have an agreement with one or more vendors of real estate financial products and services that requires the vendor to pay the Intermediary a referral fee for each hit on the vendor's site. Hence, a screen display 306 is presented to the searcher upon accessing the “coloradorealestatelistings.com” web site that asks the searcher if he or she would like to determine how much money they can borrow. The advantages of becoming prequalified for a loan are also provided on this screen that encourages the searcher to become prequalified. For example, the web page may indicate that offers may be more readily accepted, especially in a bidding war, if the purchaser is pre-qualified for a loan. In this fashion, qualified buyers are then passed to real estate office listings for a particular community, in a simple and easy manner that requires very few links. Since these potential purchasers are pre-qualified and have an interest in a particular area, the real estate listing company should agree to pay a significant referral fee to the referring agent.

For the users that continued to select the “next” button, no prequalification is provided. However, these users, as illustrated in FIG. 3, are still passed to a real estate sales company so that the Intermediary may collect referral fees from the real estate company. Of course, the leads that are not prequalified may provide a different referral fee than the prequalified buyers.

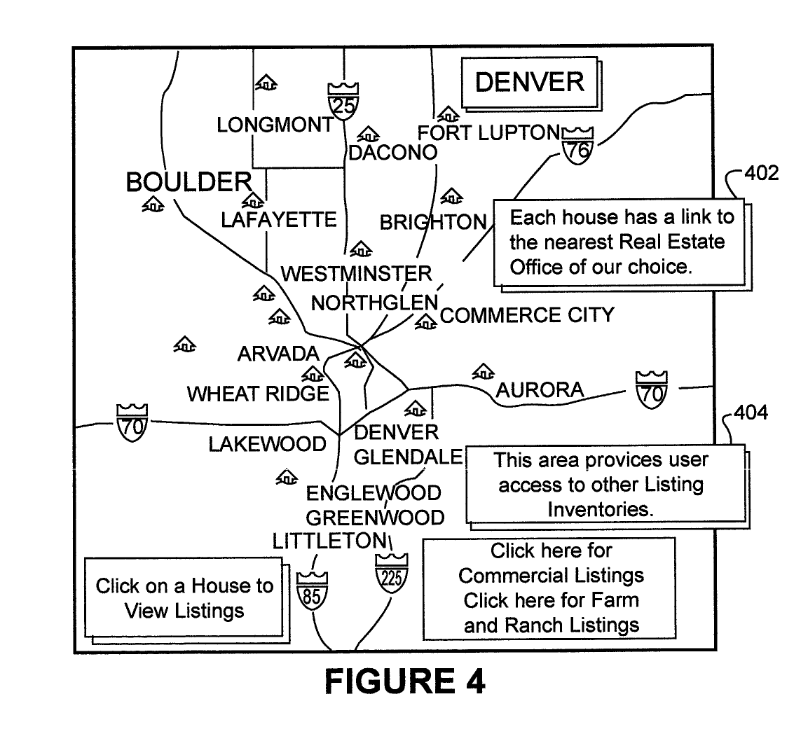

FIG. 4 is an example of a map that may be provided by either the Intermediary or a real estate sales company. The web page 400 provides links such as link 402 which may be a link to the nearest real estate office in a particular community for which the Intermediary has an agreement to pay referral fees. The links in each of the communities is shown as a small house to indicate that the residential real estate listings are provided through those links. Alternatively, the links can be used to display the real estate listings for a selected geographical area from the larger list of geographical listings for any particular sales company. As indicated at 404, the web page also provides access to other listing inventories such as commercial listings and farm or ranch listings.

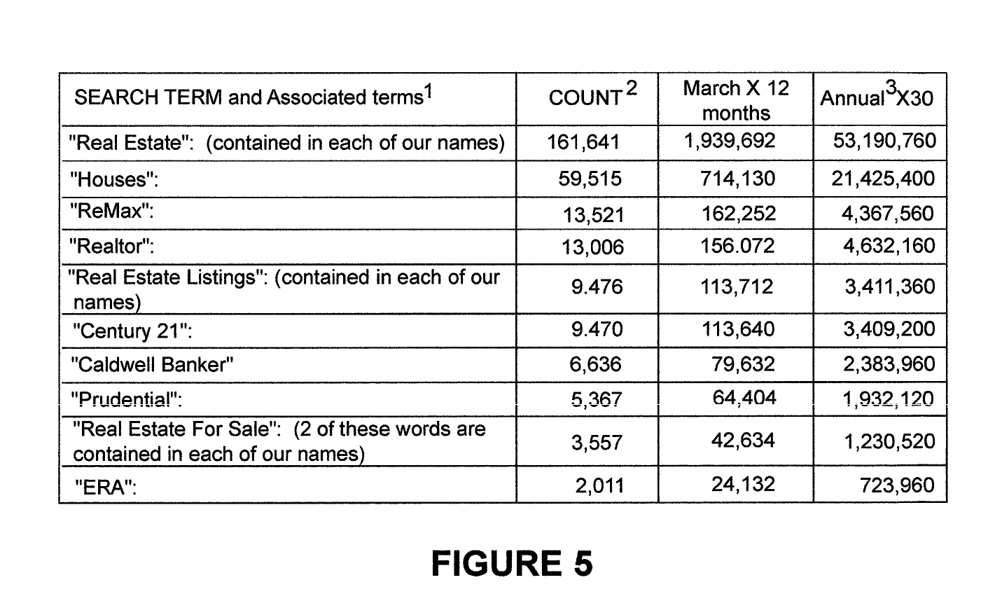

FIG. 5 is a chart illustrating searches that have used generic search terms such as “real estate,” “houses,” “real estate listings,” and other generic terms, as well as a series of brand names, on the “goto.com” search engine. Extrapolated values are also provided. This information supports the 80-20 assumptions that are set for the above.

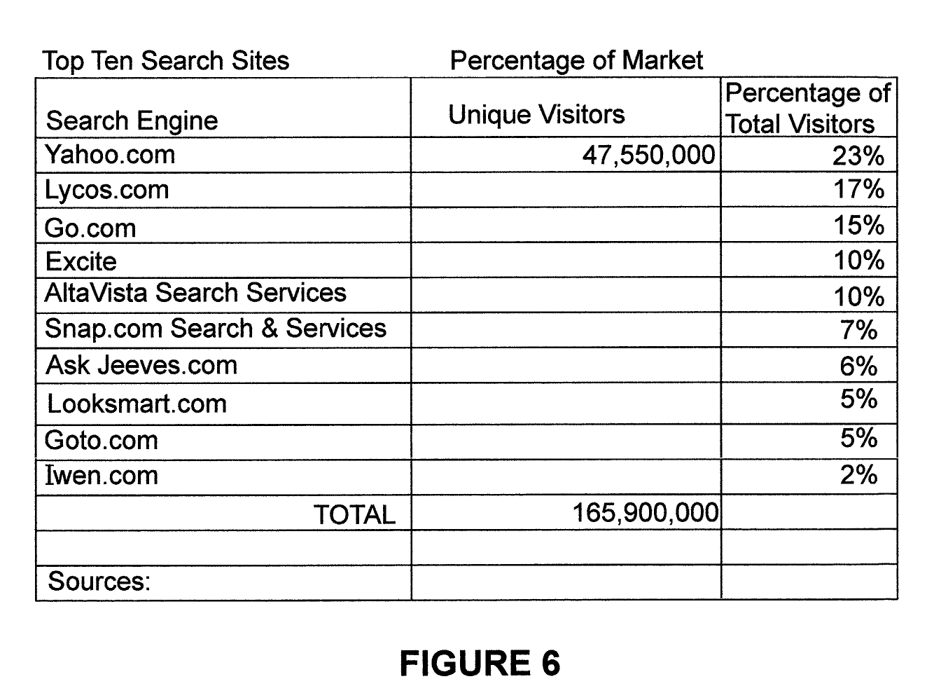

FIG. 6 is a chart of the relative market share of the goto.com search engine versus other well known search engines. By using the percentage share of each of these search engines, the number of hits on each of these terms can be extrapolated.

FIGS. 5 and 6 form a basis for establishing the 80-20 rule with respect to the use of generic search term hits versus brand name search term hits.

The present invention is also based upon the ability to use a family of domain names that use a geographically descriptive term in combination with a real estate descriptive term. For example, various cities have been used in combination with the term “realestatelistings” as a domain name. Further, states have been used in combination with the term “realestatelistings” as a domain name. Also, more generic terms such as “worldwiderealestatelistings,” “USrealestatelistings,” and other country listings. In this fashion, a tree of domain names can be established with each domain name having a geographically descriptive term in association with “realestatelistings” or other descriptive terms such as “realestate.” Other generic real estate terms include “real estate market,” “real estate multiple listings,” and “real estate online listings”. World real estate may include globalrealestatelistings, worldrealestatelistings, asiarealestatelistings, caribbeanrealestatelistings, centralamericarealestatelistings, europeanrealestatelistings, greatbritainrealestatelistings, northamericarealestatelistings, southamericarealestatelistings, unitedkingdomrealestatelistings, as well as various country real estate listings. This large tree of generic domain name listings is interlinked to gather searchers to the desired geographically descriptive domain name site. By casting the net of domain names very broadly in this fashion, searchers can be easily linked to a generic site in the domain name tree.

The present invention therefore provides a system for gathering searchers who wish to purchase real estate products and services by using a large tree of generic domain names and using the large number of hits to provide referral services to vendors of real estate products and services such as financial products and services, sales services, etc. A large net is cast by using a number of interlinked generically descriptive domain names together with geographically descriptive terminology to gather a large number of hits from Internet searchers. By using geographically descriptive domain names rather than brand names, access can be provided to a searcher in a minimal number of clicks which is a fraction of the number of clicks that are required to obtain the products and services through brand name searching.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method of obtaining referral fees by providing Internet searchers to vendors of real estate products and services comprising:
obtaining a large tree of Internet domain names that include a geographically descriptive portion and a descriptive portion relating to real estate;
encouraging searchers to access products and services first that provide larger referral fees;
providing links to specific communities within a geographically descriptive domain name.
